(19) United States
(12) Patent Application Publication
(10) Pub. No.: US 2026/0091969 A1
(43) Pub. Date: Apr. 2, 2026

(54) LABOR-SAVING SHOVEL SHAPED LID OPENER

(71) Applicant: Shenzhen Yingxiang Technology Co., Ltd., Shenzhen (CN)

(72) Inventor: SHIRU FANG, Loudi (CN)

(21) Appl. No.: 19/221,903

(22) Filed: May 29, 2025

(30) Foreign Application Priority Data
Sep. 27, 2024 (CN) 202422363124.8

(51) Int. Cl. B67B 7/18

(52) U.S. Cl. CPC B67B 7/18

(57) ABSTRACT

A labor-saving shovel shaped lid opener is provided, which includes a shovel head and a handle part integrated at one end of the shovel head. A bottom of the shovel head is provided with a stepped groove, which includes a V-shaped inner groove for cooperating with a small bottle cap and a U-shaped outer groove for cooperating with a large bottle cap. Side walls of the V-shaped inner groove and the U-shaped outer groove are embedded with two parallel sawtooth strips. The labor-saving shovel shaped lid opener is optimized in terms of sawtooth design: the V-shaped inner groove and the U-shaped outer groove are embedded with two sawtooth strips, and the two sawtooth strips, compared with one single sawtooth, it is easier to grasp a tinplate cap, thereby reducing sliding and resistance during opening, and improving opening efficiency.

### CROSS-REFERENCE TO RELATED APPLICATIONS

This application claims priority to Chinese Patent Application No. 202422363124.8, filed on September 27, 2024, which is hereby incorporated by reference in its entirety.

### TECHNICAL FIELD

The present disclosure relates to the field of bottle opener technologies, and in particular, to a labor-saving shovel shaped lid opener.

### BACKGROUND

The main product on the market now is rubber (which has poor grip, is prone to slipping, and is too bulky); single serrated handle (single serrated will damage the tin cover and make it difficult to grip the cover), the handle is not long enough. There is also a can opener screwed under the cabinet, which can only open small and light bottles.

Therefore, it is necessary to provide a labor-saving shovel shaped lid opener to solve the above technical problems.

### SUMMARY

To solve the above technical problems, the present disclosure provides a labor-saving shovel shaped lid opener.

The present disclosure provides a labor-saving shovel shaped lid opener, which includes a shovel head and a handle part integrated at one end of the shovel head; a bottom of the shovel head is provided with a stepped groove, and the stepped groove includes a V-shaped inner groove for cooperating with a small bottle cap and a U-shaped outer groove for cooperating with a large bottle cap; side walls of the V-shaped inner groove and the U-shaped outer groove are both embedded with two parallel sawtooth strips.

In some embodiments of the present disclosure, the shovel head is provided with an installation groove configured to the install the sawtooth strips, and a partition is provided between two sawtooth strips in the same installation groove; a V-shaped recess is provided at a bottom of the shovel head facing an edge of the V-shaped inner groove, and the V-shaped recess is communicated to one of the installation grooves; a V-shaped limit plate is provided in the V-shaped recess, and an installation hole is provided in the sawtooth strips; the shovel head, the sawtooth strips and the V-shaped limit plate are connected by screws;

a U-shaped recess is provided at the bottom of the shovel head facing an edge of the U-shaped outer groove, and the U-shaped recess is communicated to another installation groove; a U-shaped limit plate is provided inside the U-shaped recess; the shovel head, the sawtooth strips and the U-shaped limit plate are connected by screws.

In some embodiments of the present disclosure, the sawtooth strips are provided with a positioning hole, the installation groove is provided with a positioning column; the positioning column cooperates with the positioning hole.

In some embodiments of the present disclosure, the shovel head is provided with a first hollow groove facing the V-shaped limit plate and the U-shaped limit plate.

In some embodiments of the present disclosure, a bottom of the handle part is provided with a second hollow recess.

In some embodiments of the present disclosure, the handle part is provided with a suspension hole.

Compared with related technologies, the present disclosure provides the following beneficial effects.

### Effortless and efficient

Long handle design: the handle is designed to be longer, which conforms to the principle of leverage, allowing a user to apply less force when opening the bottle cap, thus achieving a labor-saving effect.

Optimized serrated design: two sawtooth strips are embedded in the V-shaped inner groove and U-shaped outer groove at the bottom of the shovel head. The two sawtooth strips are compared with one single sawtooth strip; it is easier to grip a tinplate lid. The serrated angle has been optimized to be smaller than traditional products, rendering it easier to hold the bottle cap, reducing sliding and resistance during the opening process, and improving opening efficiency.

### Strong universality

Stepped groove design: the stepped groove at the bottom of the shovel head includes a V-shaped inner groove and a U-shaped outer groove, which are suitable for small and large bottle caps respectively. This design enables the opener to cope with various sizes of bottle caps, thereby improving its versatility and practicality.

### BRIEF DESCRIPTION OF DRAWINGS

FIG. 1 is a schematic diagram of an overall structure of the present disclosure.

FIG. 2 is a schematic structural diagram of a distribution of stepped grooves of the present disclosure.

FIG. 3 is a schematic diagram of a relative position of a V-shaped recess and a U-shaped recess of the present disclosure.

FIG. 4 is a schematic structural diagram of a sawtooth strip of the present disclosure.

FIG. 5 is a schematic diagram of a distribution of positioning columns in the present disclosure.

Number reference: 1- shovel head; 2- handle part; 3- V-shaped inner groove; 4- U-shaped outer groove; 5- sawtooth strip; 6- installation groove; 7- partition; 8- V-shaped recess; 9- V-shaped limit plate; 10- installation hole; 11- U-shaped recess; 12- U-shaped limit plate; 13- positioning hole; 14- positioning column; 15- first hollow groove; 16- second hollow recess; 17- suspension hole.

### DESCRIPTION OF EMBODIMENTS

Further explanation of the present disclosure will be provided in combination with the accompanying drawings and embodiments.

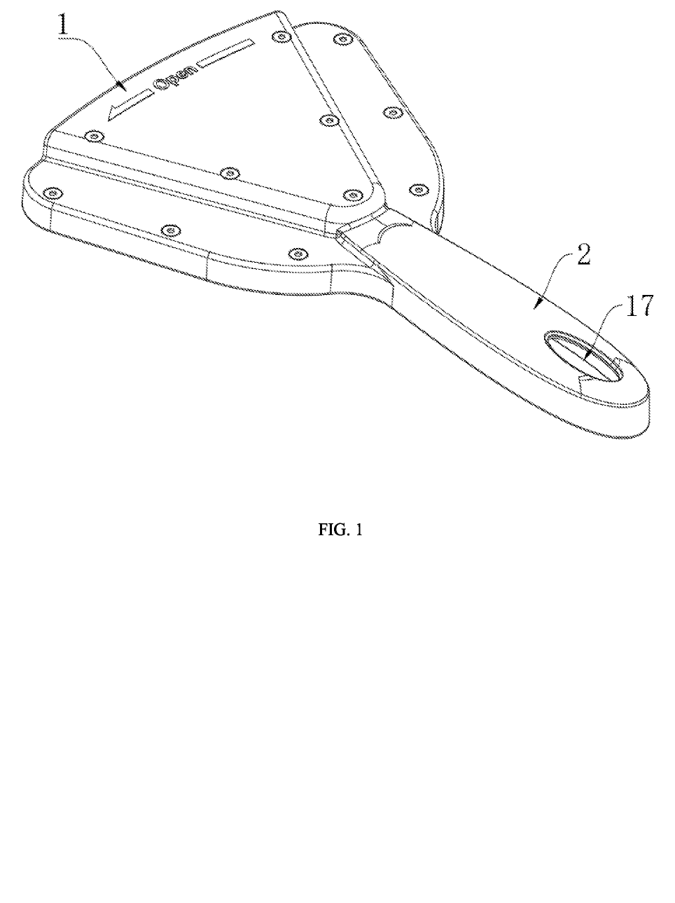

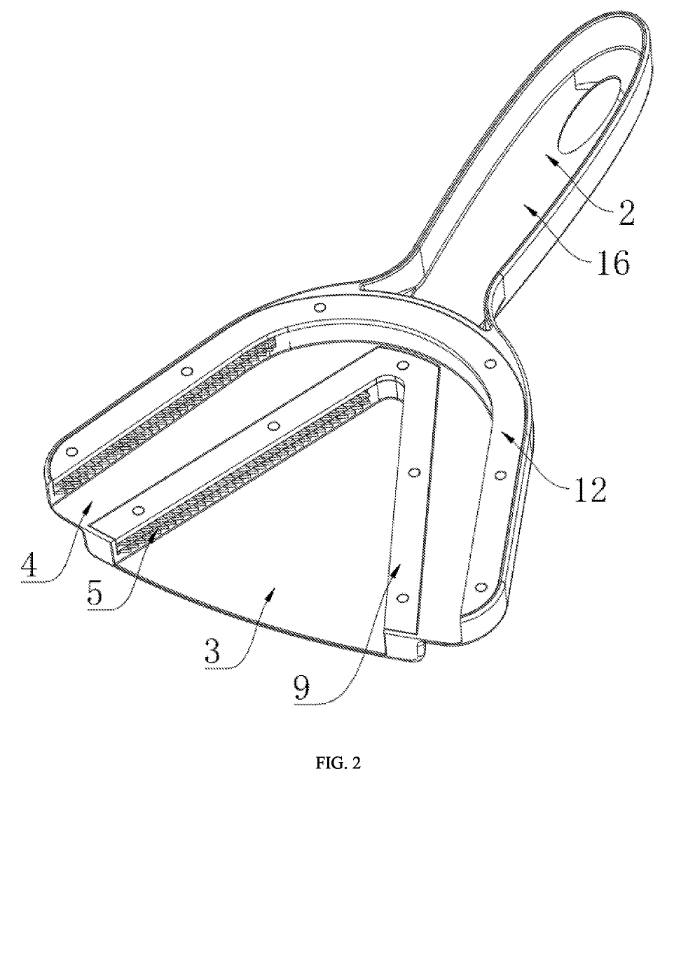

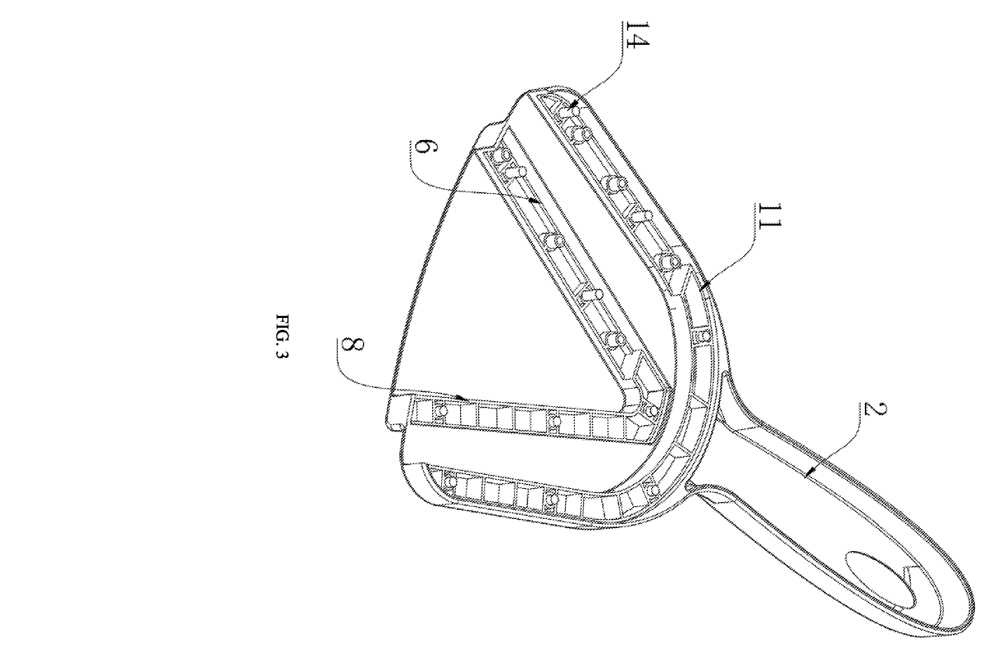

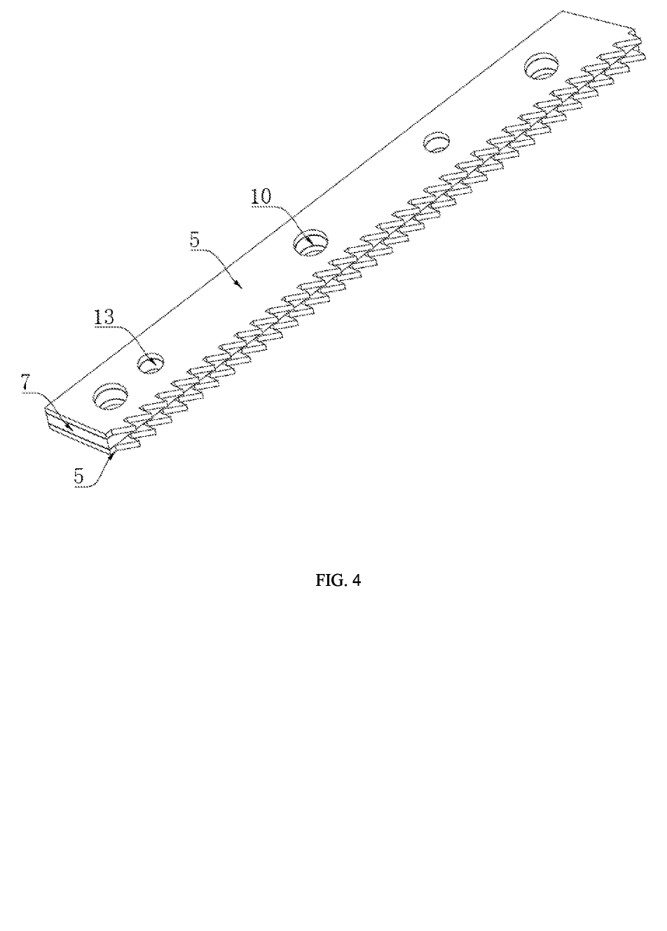

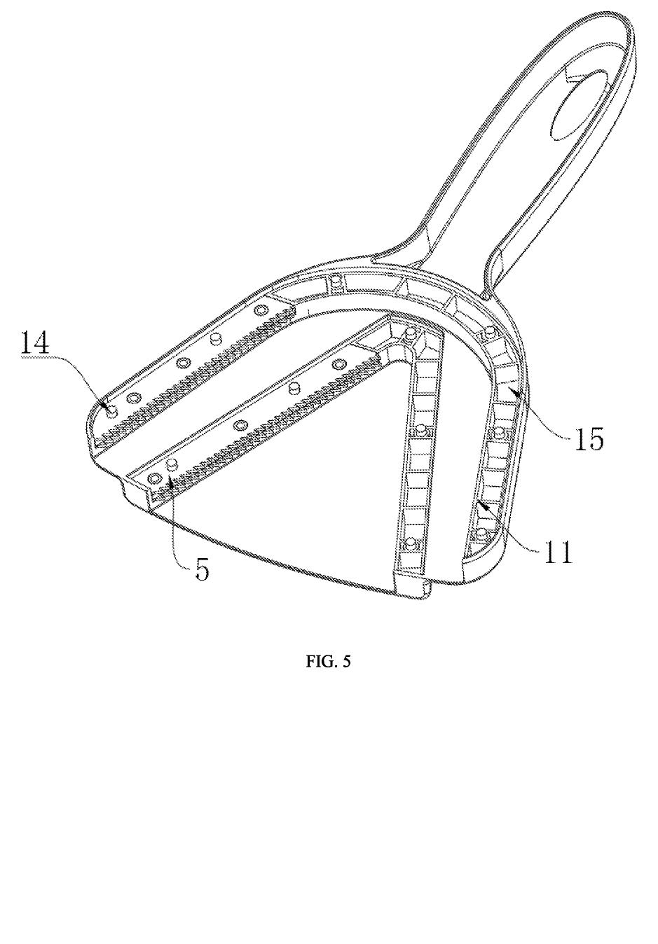

Please refer to FIGS. 1 to 5, a labor-saving shovel shaped lid opener that cleverly combines a shovel head 1 with an integrated extended handle part 2, ensuring convenient and efficient use. Compared with similar products on the market, the handle part 2 is intentionally designed to be longer. This improvement not only follows the principle of leverage, but also greatly reduces the force required during use, making it easier and more effortless to open the lid.

A bottom of the shovel head 1 is provided with a stepped groove structure to accommodate bottle caps of different sizes. In an implementation mode, the stepped groove consists of a V-shaped inner groove 3 and a U-shaped outer groove 4. The former is designed specifically for small bottle caps, and the latter is suitable for large bottle caps, thereby enhancing the versatility of the lid opener. In order to further enhance the stability when opening the lid, two parallel sawtooth strips 5 are embedded in side walls of the V-shaped inner groove 3 and the U-shaped outer groove 4. The serrated angle of these sawtooth strips 5 has been optimized to be smaller than existing products, making it easier to grip bottle caps and prevent slipping.

Inside the shovel head 1, an installation groove 6 is provided to be configured to install the sawtooth strips 5. In each installation groove 6, two sawtooth strips 5 are separated by a partition 7 to maintain their parallel relationship. In order to reinforce the installation of the sawtooth strips 5, a V-shaped recess 8 is provided at an edge of the V-shaped inner groove 3 at the bottom of the shovel head 1, and the V-shaped recess 8 is communicated to one of the installation grooves 6. The V-shaped recess 8 is provided with a V-shaped limit plate 9, and the sawtooth strips 5 are provided with an installation hole 10 to tightly connect the shovel head 1, sawtooth strips 5, and V-shaped limit plate 9 together through screws. Similarly, there is also a U-shaped recess 11 at an edge of the U-shaped outer groove 4, and the U-shaped recess 11 is communicated to another installation groove 6 and provided with a U-shaped limit plate 12, fixed using the same screw connection method.

In order to simplify the installation and disassembly process, a positioning hole 13 is further provided in the sawtooth strips 5, which matches with the positioning column 14 in the installation groove 6 to ensure that the sawtooth strips 5, V-shaped limit plate 9, and U-shaped limit plate 12 can be accurately installed in place.

Besides that, considering characteristics of plastic materials, the shovel head 1 is provided with a first hollow groove 15 at a position facing the V-shaped limit plate 9 and the U-shaped limit plate 12, effectively solving a problem of shrinkage that may occur when the plastic thickness exceeds 3 mm. The bottom of the handle part 2 is further provided with a second hollow recess 16, which saves material and reduces overall weight. A widened rounded corner design of the handle part 2 is more ergonomic and comfortable to grip. For convenient storage, the handle part 2 is further provided with a suspension hole 17, allowing a user to easily hang and store the lid opener.

The above description is only embodiments of the present disclosure and does not limit the scope of the present disclosure. Any equivalent structure or equivalent process transformation made using the content of the present disclosure specification and drawings, or directly or indirectly applied in other related technical fields, are also included in the protection scope of the present disclosure.

What is claimed is:

1. A labor-saving shovel shaped lid opener, comprising a shovel head and a handle part integrated at one end of the shovel head;
a bottom of the shovel head is provided with a stepped groove, and the stepped groove comprises a V-shaped inner groove for cooperating with a small bottle cap and a U-shaped outer groove for cooperating with a large bottle cap;
side walls of the V-shaped inner groove and the U-shaped outer groove are both embedded with two parallel sawtooth strips;
the shovel head is provided with an installation groove configured to the install the sawtooth strips, and a partition is provided between two sawtooth strips in the same installation groove;
a V-shaped recess is provided at a bottom of the shovel head facing an edge of the V-shaped inner groove, and the V-shaped recess is communicated to one of the installation grooves;
a V-shaped limit plate is provided in the V-shaped recess, and an installation hole is provided in the sawtooth strips;
the shovel head, the sawtooth strips and the V-shaped limit plate are connected by screws;
a U-shaped recess is provided at the bottom of the shovel head facing an edge of the U-shaped outer groove, and the U-shaped recess is communicated to another installation groove;
a U-shaped limit plate is provided inside the U-shaped recess; the shovel head, the sawtooth strips and the U-shaped limit plate are connected by screws.

2. The labor-saving shovel shaped lid opener according to claim 1, wherein the sawtooth strips are provided with a positioning hole, the installation groove is provided with a positioning column; the positioning column cooperates with the positioning hole.

3. The labor-saving shovel shaped lid opener according to claim 1, wherein the shovel head is provided with a first hollow groove facing the V-shaped limit plate and the U-shaped limit plate.

4. The labor-saving shovel shaped lid opener according to claim 1, wherein a bottom of the handle part is provided with a second hollow recess.

5. The labor-saving shovel shaped lid opener according to claim 1, wherein the handle part is provided with a suspension hole.
